(19) United States
(12) Patent Application Publication
(10) Pub. No.: US 2025/0320619 A1
(43) Pub. Date: Oct. 16, 2025

(54) APPARATUS AND METHOD FOR EVALUATING THE HARSH ENVIRONMENT DURABILITY OF A POROUS TRANSPORT LAYER

(71) Applicants: Hyundai Motor Company, Seoul (KR); Kia Corporation, Seoul (KR)

(72) Inventor: Young June PARK, Yangpyeong-gun (KR)

(73) Assignees: Hyundai Motor Company, Seoul (KR); Kia Corporation, Seoul (KR)

(21) Appl. No.: 19/174,430

(22) Filed: Apr. 9, 2025

(30) Foreign Application Priority Data
Apr. 12, 2024 (KR) 10-2024-0049487

(51) Int. Cl. C25B 15/08; C25B 9/15; C25B 13/02; C25B 13/05; C25B 15/027

(52) U.S. Cl. CPC C25B 15/08; C25B 9/15; C25B 13/02; C25B 13/05; C25B 15/027

(57) ABSTRACT

An apparatus for evaluating harsh environment durability of a porous transport layer of the present disclosure may include: a tank accommodating an electrolyte; a rotating portion rotating a specimen accommodated in the electrolyte; an inlet portion disposed on a side surface of the tank and configured to inject the electrolyte into the tank; and an outlet portion disposed on the side surface of the tank and configured to discharge the electrolyte from the tank.

### CROSS-REFERENCE TO RELATED APPLICATIONS

This application claims the benefit of priority to Korean Patent Application No. 10-2024-0049487, which was filed on Apr. 12, 2024, the disclosure of which is incorporated herein by reference in its entirety.

### BACKGROUND

### 1. Field

The present disclosure relates to an apparatus and a method for evaluating harsh environment durability of a porous transport layer (PTL), as well as to a method for evaluating harsh environment durability of PTL for Pt-coated Polymer Electrolyte Membrane (PEM).

### 2. Description of Related Art

A water electrolysis system generates hydrogen gas through the process of water electrolysis, which involves the splitting of water (H₂O) into hydrogen (H₂) and oxygen (O₂) using electrical energy. These systems can be broadly classified based on the type of electrolyte employed into two main categories: polymer electrolyte membrane water electrolysis (PEMWE) and alkaline water electrolysis (AWE). Among these technologies, polymer electrolyte membrane water electrolysis is particularly noted for its requirement of stable operation across a wide range of current densities. This operational flexibility is essential for achieving a high hydrogen production rate, which can reach several tens of kilograms per hour, effectively supporting diverse operating conditions and applications.

To achieve the required output levels for water electrolysis, individual unit cells are arranged in a stacked configuration, resulting in an assembled stack. Each unit cell comprises a membrane-electrode assembly (MEA) that consists of an anode and a cathode. Surrounding the MEA, a gas diffusion layer (GDL) is stacked, along with a gasket to ensure a sealed environment. Additionally, a porous transport layer (PTL) is placed on the side of the anode, along with another gasket. The stack integrates a flow field designed to supply the reaction fluid (water as the feedstock) and facilitate the discharge of the produced gases (hydrogen and oxygen). Furthermore, this flow field incorporates pathways for cooling water to circulate, allowing effective thermal management of the system. After layering hundreds of these unit cells, an end plate is affixed to the outermost part of the assembly, providing structural support to the entire stack.

An electrochemical reaction for hydrogen production via water electrolysis takes place in an electrolyte membrane and a membrane-electrode assembly. When water is supplied to the anode, which serves as the oxidation electrode in the electrolysis process, it undergoes separation into hydrogen ions (protons), electrons, and oxygen. The hydrogen ions migrate through the membrane to the cathode, functioning as the reduction electrode, while the electrons travel through an external circuit to the cathode. Concurrently, oxygen is released through the anode outlet. At the cathode, the hydrogen ions recombine with the electrons to form hydrogen gas, thereby completing the electrolysis process.

In this context, the anode of the electrolysis system operates under harsh conditions—characterized by high potential and an acidic environment—unlike the conditions typically found in fuel cells. These challenging operational parameters create a detrimental environment for the materials used in the cell. To mitigate these issues, a porous transport layer (PTL) made from titanium is employed, which offers greater durability and resistance to corrosion under such demanding conditions.

However, due to the inherent properties of titanium, it is prone to oxidation. When an oxide layer forms on its surface, both electrical and thermal conductivity of the porous transport layer are adversely affected, leading to diminished performance of the polymer electrolyte membrane electrolysis system. To address this issue, it is essential to remove any generated oxide layer and surface contaminants. Following a chemical etching process, the PTL surface should be appropriately coated with precious metals such as platinum (Pt), iridium (Ir), or gold (Au) to restore and enhance its electrical conductivity.

Conversely, if the coating layer is not properly applied, issues such as peeling, uneven coverage, and similar defects can arise. When the MEA and the separator come into contact due to these issues, exposure of titanium on the surface of the PTL may occur. This exposure can lead to the formation of an excessive oxide layer (TiOx) during system operation. As a result, the electrical conduction path may be compromised, leading to increased electrical resistance and ultimately reducing the durability of the polymer electrolyte membrane (PEM) electrolysis system.

Some studies suggest that coating quality can be inferred by measuring contact resistance; however, this approach has limitations. Specifically, if a precious metal, such as platinum (Pt), is merely deposited on the surface of the PTL without adequate bonding (yielding a bonding force of zero), the contact resistance may appear favorable. Nevertheless, this can lead to significant performance issues during operation of the PEM electrolysis system, as the Pt layer could detach completely. Additionally, other studies have proposed methods such as appearance observation, X-ray diffraction (XRD), and X-ray photoelectron spectroscopy (XPS) to evaluate coating quality. However, these techniques also fail to provide a clear assessment of the bonding strength of the Pt coating and do not allow for effective performance analysis, similar to the limitations encountered when measuring contact resistance.

As of the present filing, no published document has provided a definitive evaluation methodology for assessing the titanium porous body (PTL) coating in PEM electrolysis systems. Consequently, there is a pressing need for the development of robust evaluation technologies that can assess durability in harsh environmental conditions.

### SUMMARY

The present disclosure provides an apparatus and a method for evaluating harsh environment durability of a novel coating layer suitable for PTL surface-coated with previous metals (Pt, Ir, Au, and the like).

In embodiments, described herein is an apparatus for evaluating harsh environment durability of a porous transport layer of the present disclosure includes: a tank accommodating an electrolyte; a rotating portion rotating a specimen accommodated in the electrolyte; an inlet portion disposed on a side surface of the tank and configured to inject the electrolyte into the tank; and an outlet portion disposed on the side surface of the tank and configured to discharge the electrolyte from the tank.

In embodiments, described herein is a method for evaluating harsh environment durability of a porous transport layer of the present disclosure includes a precipitation operation of precipitating a specimen in a tank in which an electrolyte is accommodated; a rotation operation of rotating the specimen; an inflow operation of introducing the electrolyte into the tank in which the electrolyte is accommodated; and a discharge operation of discharging the electrolyte from the tank in which the electrolyte is accommodated.

In embodiments, described herein is an apparatus and a method for evaluating harsh environment durability of a porous transport layer (PTL) of the present disclosure, it may be possible to quickly identify the quality of a PTL coating layer through harsh environment evaluation while simulating the operating conditions and environment of a PEM electrolysis system.

In embodiments, described herein is an apparatus and a method for evaluating harsh environment durability of a porous transport layer (PTL) of the present disclosure, when PTL is precipitated in the electrolyte, an environment in which a reaction occurs even on an inner surface on which a plated metal is not coated may be implemented.

In embodiments, described herein is an apparatus and a method for evaluating harsh environment durability of a porous transport layer (PTL) of the present disclosure, it may be possible to implement an environment in which shear stress is applied to the PTL surface while a fluid flows in the PEM electrolysis system.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is an image showing a schematic diagram illustrating an apparatus for evaluating harsh environment durability of a porous transport layer (PTL);

FIG. 2A and FIG. 2B are images of electron micrographs comparing PTLs before (a) and after (b) harsh environment durability evaluation according to the evaluation method of the present disclosure; and

FIG. 3 is a graph showing performance comparison data of PTL (Inventive Example 1) measured according to the evaluation method of the present disclosure and PTL (Comparative Example 1) using an actual water electrolysis system.

### DETAILED DESCRIPTION

Hereinafter, preferred embodiments of the present disclosure will be described with reference to the attached drawings. However, the embodiments of the present disclosure may be modified to have various other forms, and the scope of the present disclosure is not limited to the embodiments described below.

A harsh environment durability evaluation of the porous transport layer is an evaluation for quickly determining the quality of a PTL coating layer by simulating operating conditions and an environment of a PEM electrolysis system.

In the PEM electrolysis system, PTL may be combined due to the exposure of Ti to a PTL surface, Pt undergoing Ostwald ripening, dissolution and redeposition, and a Pt migration shape. Here, Ostwald ripening is a phenomenon observed in solid solutions and liquid sols that accompany non-uniform structural changes over time, where small crystals or sol particles are first dissolved and then redeposited on larger crystals or sol particles.

In the case of the conventional art, Ti is exposed due to the pressure of oxygen gas generation by overpotential centered on a region in which cracks exist in the PTL surface Pt coating, and only the deterioration of the coating layer due to the expansion of a Ti exposure portion is accelerated.

Accordingly, the present disclosure may quickly identify the quality of the PTL coating layer through harsh environment evaluation while simulating the operating conditions and environment of the PEM electrolysis system, and may simultaneously generate an environment in which a reaction occurs even on an inner surface on which a coating layer is not coated when the PTL is precipitated in a reactant due to the characteristics of the porous body, that is, the same environment that the PTL experiences in the actual PEM electrolysis system, thereby improving the accuracy of the experiment.

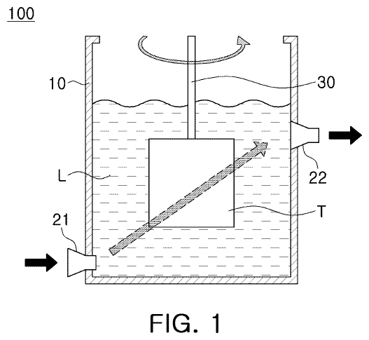

FIG. 1 is a schematic diagram illustrating an apparatus 100 for evaluating harsh environment durability of a porous transport layer (PTL) of the present disclosure. Referring to FIG. 1, the apparatus 100 for evaluating harsh environment durability of the porous transport layer of the present disclosure may include a tank 10 accommodating an electrolyte L, a rotating portion 30 rotating a specimen T accommodated in the electrolyte L, an inlet portion 21 disposed on a side surface of the tank 10 and configured to inject the electrolyte L into the tank 10, and an outlet portion 22 disposed on the side surface of the tank 10 and configured to discharge the electrolyte L from the tank 10.

The apparatus 100 for evaluating harsh environment durability of the porous transport layer according to an embodiment of the present disclosure may be used in two electrodes or three electrodes, and FIG. 1 is a schematic diagram showing the apparatus 100 for evaluating harsh environment durability of the porous transport layer in three electrodes.

The present disclosure may include a tank 10 accommodating the electrolyte L. The tank 10 may accommodate the electrolyte L and may conduct a harsh environment durability evaluation of a coating layer of a PTL precipitated in the electrolyte L. The electrolyte L may be an aqueous solution in which an electrolyte is mixed in water.

The electrolyte L may be changed according to a reference electrode to be evaluated, and the electrolyte L may be at least one selected from the group consisting of a sulfuric acid aqueous solution, a nitric acid aqueous solution, a hydrochloric acid aqueous solution, and the like, but the present disclosure is not particularly limited thereto, and for example, a sulfuric acid aqueous solution may be used as the electrolyte L in the reference electrode Hg/Hg₂SO₄ electrode.

A temperature of the electrolyte L may be 20 to 100° C., specifically 20 to 60° C., and more specifically 25 to 40° C. In the temperature range, the occurrence of experimental deviation due to an external atmospheric temperature may be reduced.

The pH of the electrolyte L may be appropriately changed according to the experimental environment.

A working electrode of the present disclosure may be a specimen T. The specimen T may be a porous transport layer (PTL) coated with a plated metal.

The plated metal may be at least one selected from platinum (Pt), iridium (Ir), and gold (Au), and specifically, Pt.

The porous transport layer may include at least one selected from the group consisting of titanium (Ti), nickel (Ni), and stainless steel, and specifically, Ti. A shape of titanium may be at least one selected from the group consisting of a circular shape, an oval shape, an irregular shape, and a fiber shape, and the present disclosure is not particularly limited.

A potential applied to the PTL inside the PEM water electrolysis system is about 2.0 V. Thermodynamically, a large amount of oxygen bubbles is generated by an OER reaction from 1.23 V. For this reason, when oxygen bubbles are generated inside, an aqueous solution and the specimen T may not come into contact, which may increase the inaccuracy of the experiment.

A PTL, which is a porous body formed of a titanium material, is used as the PTL used in the PEM water electrolysis system, and thus, since the Ti material is easily oxidized, the electrical conductivity/thermal conductivity of PTL decreases when forming an oxide layer, and thus the performance of the PEM water electrolysis system decreases.

Additionally, a potential applied to the PTL inside the PEM electrolysis system is approximately 2.0 V. Due to the characteristics of the porous body, countless oxygen bubbles are generated and remain on a surface due to an Oxygen Evolution Reaction (OER) reaction with an iridium (Ir)-based electrode, and thermodynamically, a large number of oxygen bubbles are generated by the OER reaction from 1.23 V. For this reason, when oxygen bubbles are generated inside, the aqueous solution and the specimen T may not come into contact, which may increase the inaccuracy of the experiment.

In the present disclosure, by immediately removing the bubbles generated while the specimen T rotates, the reliability of the data may be increased by allowing the electrolyte L to be always in contact with a surface of the specimen T.

Accordingly, the present disclosure may include a rotating portion 30 rotating the specimen T included in the electrolyte L. One end of the rotating portion 30 may be attached to the specimen T, and the other end may be connected to a rotational power for rotating the rotating portion 30, so that the rotating portion may be rotated by the rotational power. The rotational power is not particularly limited as long as it is a device for rotating the specimen T, and may be, for example, a motor.

The rotating portion 30 may be rotated at 50 to 3,000 RPM, and specifically, may be rotated at 100 to 1,000 RPM. When the RPM of the rotating portion 30 is less than 100, the air bubbles generated on the surface of the specimen T may not be sufficiently removed, and when the RPM exceeds 1,000, errors may occur due to heat generation.

The tank 10 may further include a stirrer. The stirrer may immediately remove bubbles generated on the PTL surface by stirring the electrolyte L in the tank 10. The stirrer may be disposed in the tank 10, and the present disclosure is not particularly limited, but for example, a magnetic stirrer, or the like, may be used.

In an actual PEM electrolysis system, shear stress is applied to the PTL surface as the fluid flows. The existing coating layer harshness evaluation technology performs harshness evaluation by adjusting the potential/pH in a steady static state, from which the accuracy of the experiment is reduced, and the experiment is different from an environment that the PTL experiences in an actual system, and accordingly, there is a problem that evaluation results may be somewhat different from the results of using the actual PEM electrolysis system.

The present disclosure simulates an environment in which shear stress is applied to the surface of a specimen T as the fluid flows in an actual PEM electrolysis system, and simulates an environment in which water flows in and out, similarly to the occurrence in an actual environment and generates an environment from which oxygen bubbles are removed by rotating a PTL holder, thereby improving the accuracy of the experiment.

Hereinafter, the present disclosure may include an inlet portion 21 disposed on the side surface of the tank 10 and configured to inject the electrolyte L into the tank 10, and an outlet portion 22 disposed on the side surface of the tank 10 and configured to discharge the electrolyte L from the tank 10.

Referring to FIG. 1, the outlet portion 22 of an embodiment of the present disclosure may be disposed on the side surface of the tank 10 opposite to the inlet portion 21. Since the inlet portion 21 and the outlet portion 22 are disposed on opposite sides of the tank 10, ae distance between the inlet portion 21 and the outlet portion 22 increases, so that shear stress may be more easily applied.

The speed of the electrolyte L flowing in/out from the inlet portion 21 and the outlet portion 22 may be the same, or the inflow/outflow speed may be arbitrarily adjusted depending on the content of the electrolyte L contained in the tank 10.

A flow rate of the electrolyte L flowing in/out from the inlet portion 21 and outlet portion 22 may be 0.5 to 150 m³/s, and specifically, this may be 10 to 100 m³/s. When the flow rate is less than 0.5 m³/s, the shear stress may not be sufficiently formed and it may be difficult to maintain the temperature, and when the flow rate exceeds 150 m³/s, experimental errors may increase due to excessive flow rate.

Additionally, referring to FIG. 1, the inlet portion 21 of an embodiment of the present disclosure may be disposed in a lower end of the side surface, and the outlet portion 22 may be disposed in an upper end of the side surface, or the inlet portion 21 may be disposed in the upper end of the side surface, and the outlet portion 22 may be disposed in the lower end of the side surface. That is, by forming a height difference between the inlet portion 21 and the outlet portion 22 disposed on the side surface of the tank 10, the shear stress may be more easily applied.

Additionally, PTL generates a high exothermic reaction when a potential is applied due to high resistance thereof, which causes evaporation of the electrolyte L and increases the content of the electrolyte. In this case, the experimental conditions change during the experiment, but the present disclosure may play a role in increasing the reliability of the experiment by maintaining the content of the electrolyte by continuously introducing/discharging a reactant fluid.

In addition, by continuously introducing/discharging the reactant fluid from the inlet portion 21 and outlet portion 22, a temperature of the apparatus 100 of harsh environment evaluation device and/or the tank 10 may be maintained constantly.

Another embodiment of the present disclosure may provide a method for evaluating harsh environment durability of a porous transport layer. The method for evaluating the harsh environment durability of the porous transport layer may include a precipitation operation of precipitating a specimen T in a tank 10 in which an electrolyte L is accommodated, a rotation operation of rotating the specimen T, an inflow operation of introducing an electrolyte L into the tank 10 in which the electrolyte L is accommodated, and a discharge operation of discharging the electrolyte L from the tank 10 in which the electrolyte L is accommodated.

The rotation operation, the inflow operation, and the discharge operation may be performed simultaneously or individually, and specifically, the rotation operation, the inflow operation, and the discharge operation may be performed simultaneously. The rotation operation, the inflow operation, and the discharge operation are performed simultaneously to remove bubbles formed on the surface of the specimen T, and shear stress may be applied to the surface of the specimen T, so that an entire surface coating layer of the specimen T may be rapidly deteriorated, and the same environment experienced by the specimen T in an actual PEM electrolysis system may be provided.

### EXAMPLE

Hereinafter, the present disclosure will be described in more detail through specific examples. The following examples are merely examples to help understand the present disclosure, and the scope of the present disclosure is not limited thereto.

### Inventive Example 1 and Comparative Example 1

### 1. Inventive Example 1

The apparatus for evaluating harsh environment durability of the porous transport layer according to FIG. 1 was used to conduct a harsh environment durability evaluation of PTL.

Hg/HgSO₄ was used as a reference electrode, 0.5 g of PTL coated with Pt was used as a working electrode, and 1 M H₂SO₄ was used as an electrolyte. The tank temperature was maintained at 25° C., the rotation speed of the rotating portion was 150 RPM, the electrolyte inflow/outflow flow rate was 10 m³/s, and the system was driven at 900 mV for 200 hours.

### 2. Comparative Example 1

The PEM electrolysis system was driven at 900 m V for 3,500 hours using 0.5 g of PTL coated with Pt using the working electrode.

### Evaluation Example

### 1. Appearance Comparison

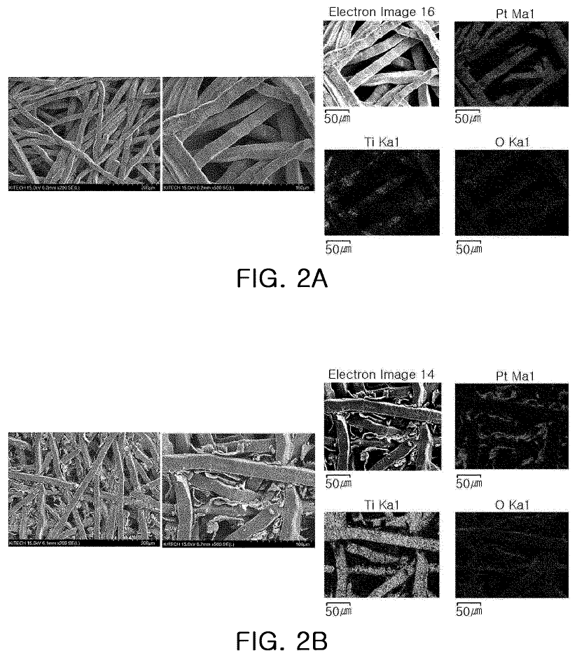

The PTL before and after an evaluation of Inventive Example 1 were captured with an electron microscope and are shown in FIG. 2.

Referring to FIG. 2, it may be confirmed that almost all of the Pt is removed from the PTL surface in which the PTL and MEA come into contact.

### 2. Deterioration Rate Comparison

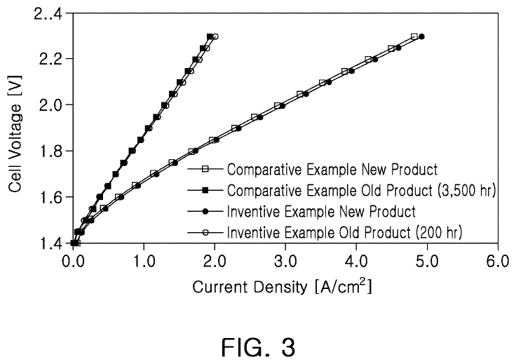

The current density of the PTL of Inventive Example 1 and Comparative Example 1 was measured to measure a difference in deterioration rate, and results thereof are shown in Table 1 below. Additionally, performance comparison data of PTL (Inventive Example 1) measured according to the evaluation method of the present disclosure and PTL (Comparative Example 1) using an actual water electrolysis system are shown in FIG. 3.

TABLE 1

| | | Current Density (@ | |
|---|---|---|---|
| | | 2.0 V) | Deterioration |
| | State | (A/cm²) | Rate (%) |
| Comparative | Before use | 2.870 | 55.36 |
| Example 1 | After use | 1.281 | |
| Inventive | Before the evaluation | 2.950 | 54.92 |
| Example 1 | After the evaluation | 1.330 | |

Referring to Table 1 and FIG. 3, as a result of the harsh environment durability evaluation (Inventive Example 1) of PTL according to the evaluation method of the present disclosure, the deterioration rate is 54.92%, and the deterioration rate of PTL (Comparative Example 1) using an actual water electrolysis system is 55.36%, and thus, it may be confirmed that the deterioration rates are significantly similar to each other.

Although the example embodiment of the present disclosure has been described in detail above, it will be obvious to those skilled in the art that the scope of the present disclosure is not limited thereto, and various modifications and variation may be made without departing from the technical concept of the present disclosure described in the claims.

What is claimed is:

1. An apparatus for evaluating harsh environment durability of a porous transport layer, comprising:
a tank accommodating an electrolyte;
a rotating portion rotating a specimen accommodated in the electrolyte;
an inlet portion disposed on a side surface of the tank and configured to inject the electrolyte into the tank; and
an outlet portion disposed on the side surface of the tank and configured to discharge the electrolyte from the tank.

2. The apparatus for evaluating harsh environment durability of a porous transport layer according to claim 1, wherein the outlet portion is disposed on the side surface of the tank opposite to the inlet portion.

3. The apparatus for evaluating harsh environment durability of a porous transport layer according to claim 1, wherein the inlet portion is disposed in a lower end of the side surface, and the outlet portion is disposed in an upper end of the side surface.

4. The apparatus for evaluating harsh environment durability of a porous transport layer according to claim 1, wherein the inlet portion is disposed in an upper end of the side surface, and the outlet portion is disposed in a lower end of the side surface.

5. The apparatus for evaluating harsh environment durability of a porous transport layer according to claim 1, wherein the tank further includes a stirrer.

6. A method for evaluating harsh environment durability of a porous transport layer, comprising:
a precipitation operation of precipitating a specimen in a tank in which an electrolyte is accommodated;
a rotation operation of rotating the specimen;
an inflow operation of introducing the electrolyte into the tank in which the electrolyte is accommodated; and
a discharge operation of discharging the electrolyte from the tank in which the electrolyte is accommodated.

7. The method for evaluating harsh environment durability of a porous transport layer according to claim 6, wherein a temperature of the electrolyte is 20 to 100° C.

8. The method for evaluating harsh environment durability of a porous transport layer according to claim 6, wherein the electrolyte is at least one selected from the group consisting of a sulfuric acid aqueous solution, a nitric acid aqueous solution, a hydrochloric acid aqueous solution, and a hydrofluoric acid aqueous solution.

9. The method for evaluating harsh environment durability of a porous transport layer according to claim 6, wherein the rotation operation, the inflow operation, and the discharge operation are performed simultaneously.

10. The method for evaluating harsh environment durability of a porous transport layer according to claim 6, further comprising:
a stirring operation of stirring the electrolyte in the tank with a stirrer.

11. The method for evaluating harsh environment durability of a porous transport layer according to claim 6, wherein the specimen is a porous transport layer (PTL) coated with a plated metal.

12. The method for evaluating harsh environment durability of a porous transport layer according to claim 11, wherein the porous transport layer includes at least one selected from the group consisting of titanium (Ti), nickel (Ni), and stainless steel.

13. The method for evaluating harsh environment durability of a porous transport layer according to claim 12, wherein a shape of the titanium includes at least one selected from the group consisting of a circular shape, an oval shape, an irregular shape, and a fiber shape.

14. The method for evaluating harsh environment durability of a porous transport layer according to claim 11, wherein the plated metal includes at least one selected from platinum (Pt), iridium (Ir), and gold (Au).
